(19) United States
(12) Patent Application Publication
(10) Pub. No.: US 2026/0065925 A1
(43) Pub. Date: Mar. 5, 2026

(54) System and Method for Emotion-Aware Digital Communication

(71) Applicant: James Seebock, Henderson, NV (US)

(72) Inventor: James Seebock, Henderson, NV (US)

(21) Appl. No.: 19/289,069

(22) Filed: Aug. 3, 2025

Related U.S. Application Data
(60) Provisional application No. 63/689,716, filed on Sep. 1, 2024.

(51) Int. Cl. G10L 25/63; G06F 40/30; G06T 11/00

(52) U.S. Cl. CPC G10L 25/63; G06F 40/30; G06T 11/10

(57) ABSTRACT

The present invention provides a digital communication system that uses an advanced artificial intelligence (AI) model to detect and reflect the emotional tone of messages. It integrates real-time text analysis, personalized learning, multimodal inputs (including facial and vocal emotion detection), and user-defined slang mapping for a richer emotional context. The system captures emotional trends over time, adapts background colors to reflect overall emotional tones, provides timely emotional support through alerts based on significant emotional trends, and supports seamless integration across multiple platforms for consistent emotional feedback. This invention enhances emotional understanding in digital communication, addressing limitations of existing systems by combining multimodal analysis with proactive emotional support mechanisms.

### BACKGROUND OF THE INVENTION

Digital communication has become the dominant form of interpersonal interaction, including text messaging, social media, and email. However, these platforms often fail to effectively convey the emotional context of messages, leading to misunderstandings and reduced emotional depth in conversations.

Existing systems primarily rely on emojis or tone indicators, which are limited in their ability to capture the full range of human emotions. For example, prior art systems such as sentiment analysis tools (e.g., IBM Watson Tone Analyzer) focus on broad sentiment categories (positive, negative, neutral) and lack granular emotion classification.

Similarly, emoji-based systems in messaging apps (e.g., WhatsApp) provide user-selected emotional indicators but do not dynamically analyze emotional context in real-time. There is a need for a more comprehensive solution that can interpret and reflect the emotional tone of digital communications, providing users with deeper emotional insights and more meaningful connections.

Further, there is a critical need for systems that provide real-time emotional analytics and proactive alerts to support users experiencing significant negative emotions, potentially preventing mental health crises such as suicides through timely intervention.

### SUMMARY OF THE INVENTION

This invention comprises a digital communication platform that uses a sophisticated AI-driven emotion classification framework to analyze and reflect the emotional tone of text messages, social media posts, and emails. The system employs a structured emotion classification model, inspired by frameworks such as the Gloria Wilcox Feelings Wheel, to categorize emotions into granular groups (e.g., joy, sadness, anger, fear) with high precision.

It leverages multimodal inputs (text, facial expressions, and vocal tones) for more accurate emotion detection, offers personalized learning for improved emotional analysis over time, and includes unique features such as user-defined slang mapping, adaptive background colors, real-time emotional analytics, proactive emotional support alerts, and seamless cross-platform integration.

### DETAILED DESCRIPTION OF THE INVENTION

The present invention is a system that enhances digital communication by integrating a multi-layered AI architecture for emotion-aware interactions across text messaging, social media, and email platforms. The system comprises the following components:

### Emotion-Aware AI

The system uses an emotion classification framework that categorizes human emotions into structured groups based on a hierarchical model with primary, secondary, and tertiary emotion categories (e.g., joy, contentment, elation)], allowing the AI to assign a dominant emotion to each message.
The system analyzes typed text in real-time using natural language processing (NLP) techniques, including transformer-based models (e.g., BERT) trained on an annotated emotional dataset comprising a diverse corpus of text samples labeled with primary, secondary, and tertiary emotions, sourced from public and proprietary datasets to ensure robust emotional classification across varied linguistic contexts, to identify and assign a dominant emotion, converting the message text color to match the expressed feeling (e.g., blue for sadness, red for anger).
The AI-driven emotion detection module includes a color-emotion mapping database that stores predefined associations between emotions (e.g., joy, sadness) and corresponding text colors (e.g., yellow, blue), enabling dynamic color conversion of messages based on the detected dominant emotion.
Analyzes the ongoing typed text thread or conversation based on a predetermined time period (e.g., last 24 hours or user-defined interval) to identify and assign a dominant emotion, converting the background color of the user interface screen behind the text thread to match the overall expressed feeling of the entire conversation.
Supports personalized AI learning by allowing users to verify detected emotions, updating the model's weights via supervised learning to improve accuracy for individual users.
Allows users to add their own slang or personalized phrases, mapping them to specific emotions for a more customized emotional analysis using a user-accessible slang-emotion mapping database that stores slang-emotion pairs. The slang-emotion mapping database enables personalized emotional analysis by the AI-driven emotion detection module, enhancing the transformer-based NLP model's accuracy for individual users.
Continuously updates its emotional understanding based on real-time user feedback, creating a personalized emotional AI model stored locally or in a secure cloud environment.
The transformer-based NLP model integrates user feedback, multimodal inputs, and slang mappings to enhance the AI-driven emotion detection module's accuracy, as described in the system's various operational modes.

### Adaptive Emotional Analytics

Captures emotional data from user messages over time, providing insights into emotional trends and patterns using time-series analysis to track emotional shifts.
Adapts the background color of the messaging screen based on the user's overall emotional tone over a set period, reflecting broader emotional shifts rather than just immediate conversations.
Quickly identifies the top messages that contributed to the overall emotional trend, allowing users to understand the key drivers behind their emotional analytics, including generating a list of top messages that most significantly influenced the overall emotional state via a weighted scoring algorithm that ranks messages by emotional intensity.
Includes a proactive alert system that monitors emotional trends using predefined thresholds (e.g., sustained sadness or anger scores above 80% for 24 hours) and automatically sends alert messages to pre-identified contacts when significant negative emotions are detected, facilitating timely emotional support.

### Multimodal Emotion Detection

Integrates smartphone and computer cameras for real-time facial emotion analysis, using convolutional neural networks (CNNs) trained on facial expression datasets, enhancing the emotional context as users type or speak their messages.

Supports spoken emotion detection for text-to-speech inputs, capturing vocal tones and expressions via mel-frequency cepstral coefficient (MFCC) analysis for more accurate emotional analysis.

### Seamless Multi-platform Integration

Designed for seamless use across smartphone text messaging apps, social media platforms, and computer email clients, ensuring a consistent emotional experience across all digital communication channels through a unified API that synchronizes emotional data across platforms.

### Technical Implementation Details

The system is implemented using a modular architecture comprising:
A client-side application (available on iOS, Android, and web browsers) that handles user inputs, camera feeds, and voice inputs.
A server-side AI engine running on a cloud infrastructure, utilizing transformer-based NLP models (e.g., BERT) for text analysis, CNNs for facial recognition, and MFCC-based models for voice analysis.
A secure user-specific database for storing user-defined slang-emotion mapping database and personalized AI model parameters, compliant with data privacy regulations (e.g., GDPR, CCPA).
Continuously updates its emotional understanding based on real-time user feedback, creating a personalized emotional AI model stored locally or in a secure cloud environment.
A real-time analytics dashboard displaying emotional trends, accessible via the client application. The system ensures low-latency processing (e.g., <100 ms for text analysis) to provide seamless real-time feedback.

### Conclusion

This invention represents a significant advancement in digital communication, providing a more emotionally aware experience through innovative AI, analytics, user feedback, emotional support alerts that could potentially prevent suicides and multimodal integration. The system addresses the limitations of current text-based communication platforms, creating deeper, more meaningful digital interactions, and a better understanding of personal expressed emotional trends.

### DETAILED DESCRIPTION OF DRAWINGS

### Figures

FIG. 1: Emotion Detection and Text Color Mapping

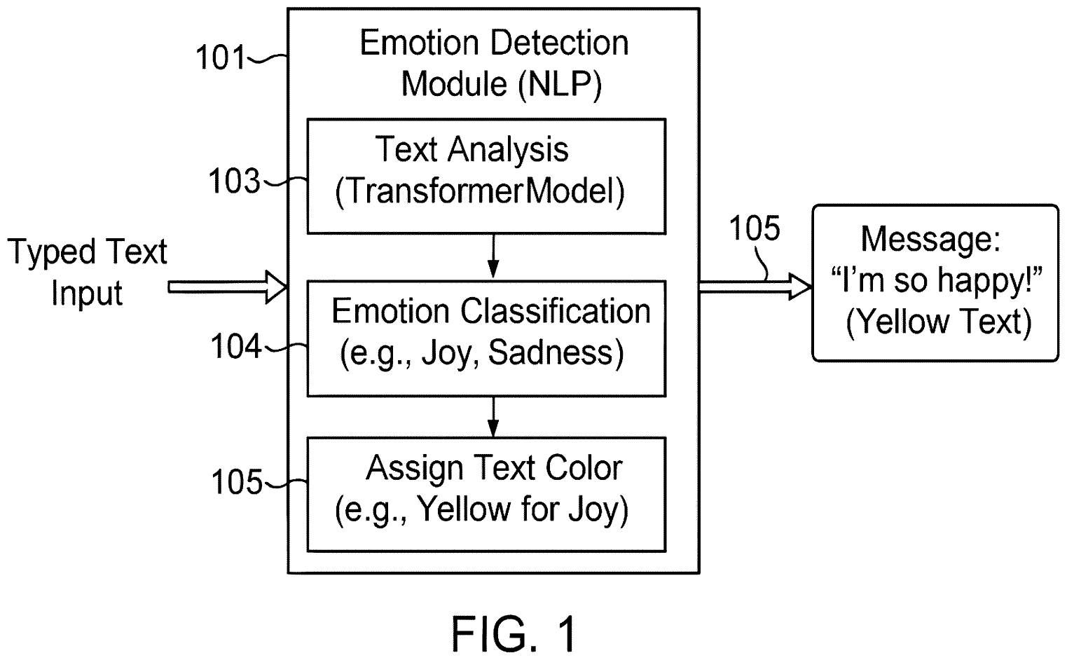

Diagram showing the AI-driven emotion detection module analyzing typed text via NLP, assigning a dominant emotion (e.g., joy), and changing the text color (e.g., yellow).

FIG. 2: Real-Time Emotion Verification Feedback Flowchart illustrating the user feedback mechanism where the sender confirms or adjusts the AI-detected emotion before message transmission.

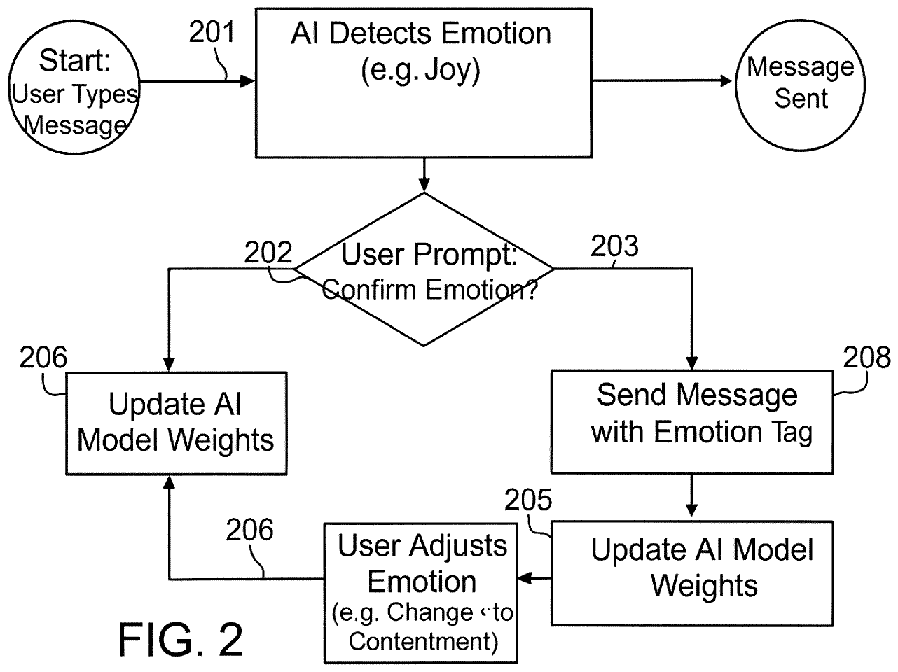

FIG. 3: Adaptive Background Coloring

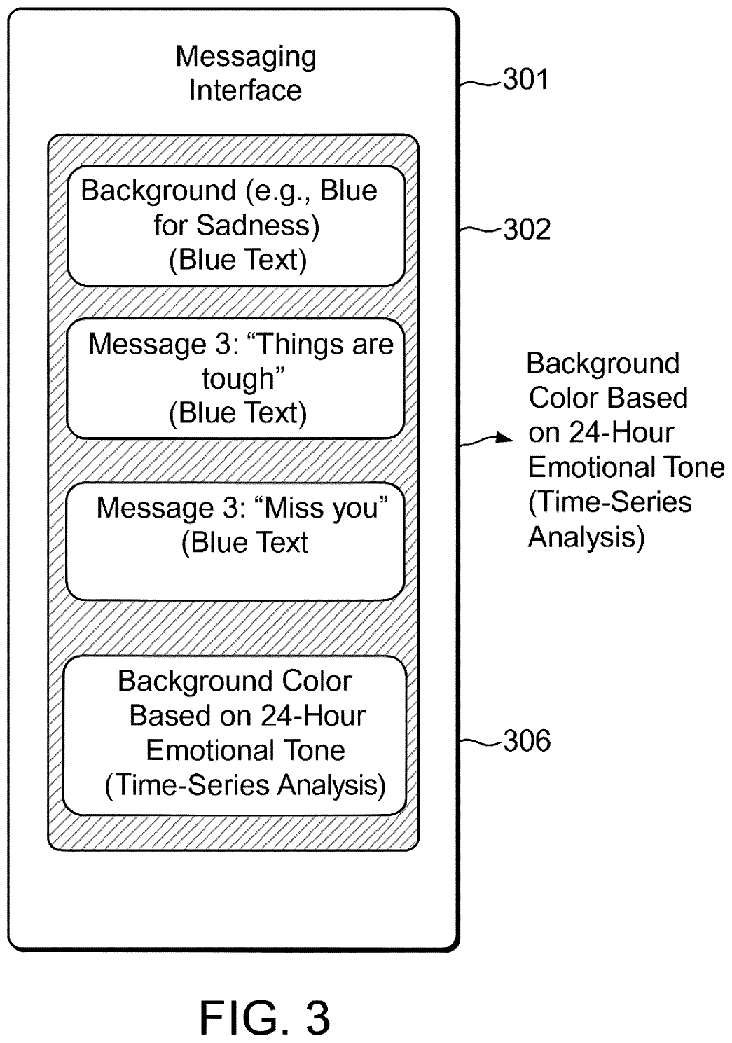

Illustration of a messaging screen where the background color changes (e.g., blue for sadness) based on the cumulative emotional tone over a period (e.g., 24-hour period).

FIG. 4: Emotional Analytics and Trend Identification

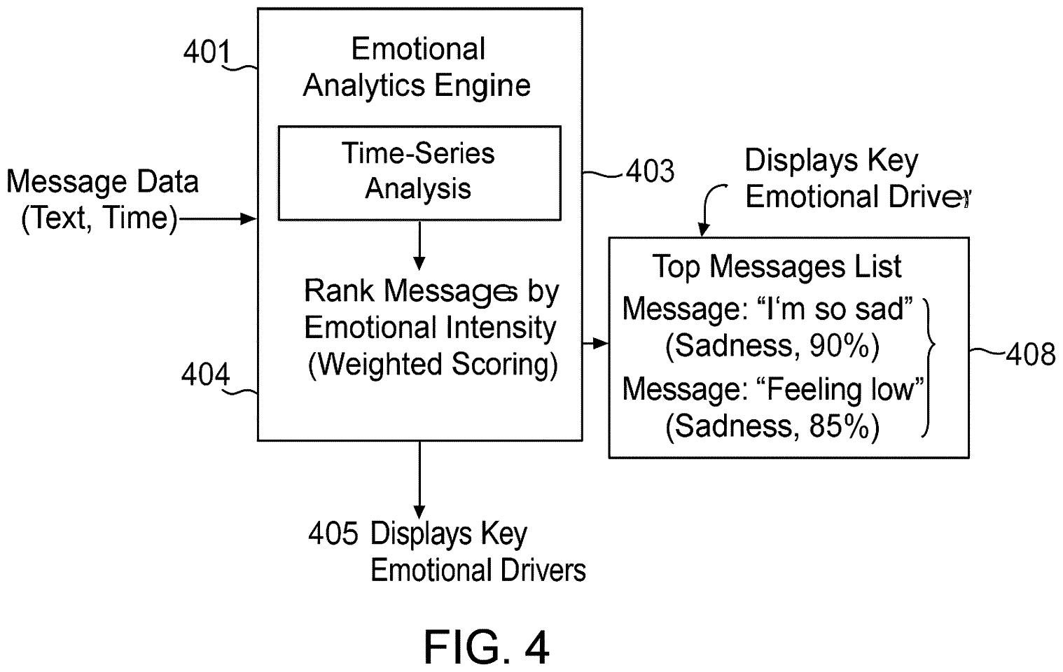

Diagram showing the analytics engine ranking messages by emotional intensity and displaying a list of top messages contributing to the user's emotional trend.

FIG. 5: Automated Emotional Support Alert System

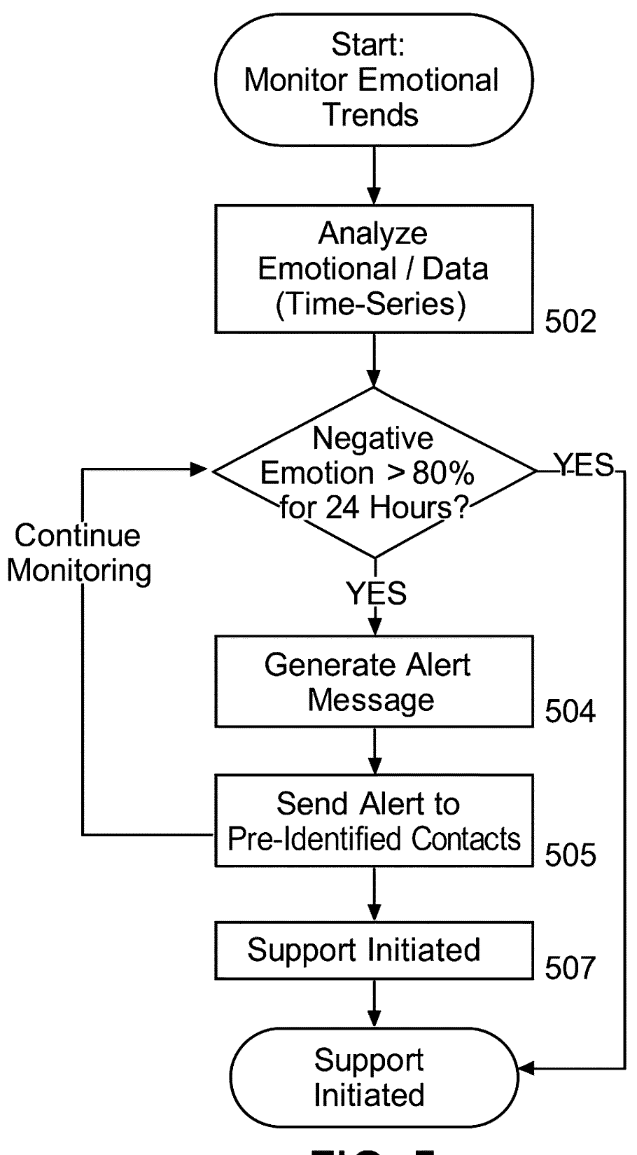

Flowchart depicting the process of detecting sustained negative emotions (e.g., sadness score>80%) and sending alerts to pre-identified contacts.

FIG. 6: Facial Emotion Recognition

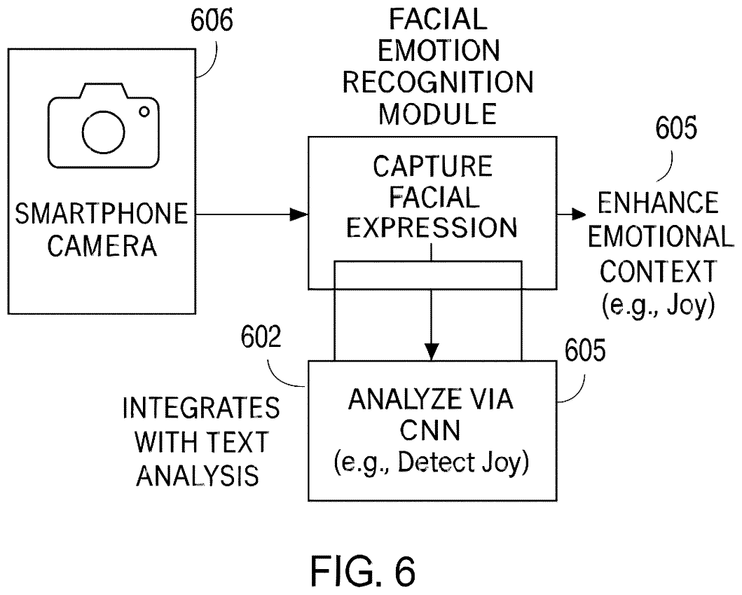

Diagram illustrating the use of a smartphone camera to capture facial expressions, processed by a CNN to enhance emotional context.

FIG. 7: Voice Emotion Detection

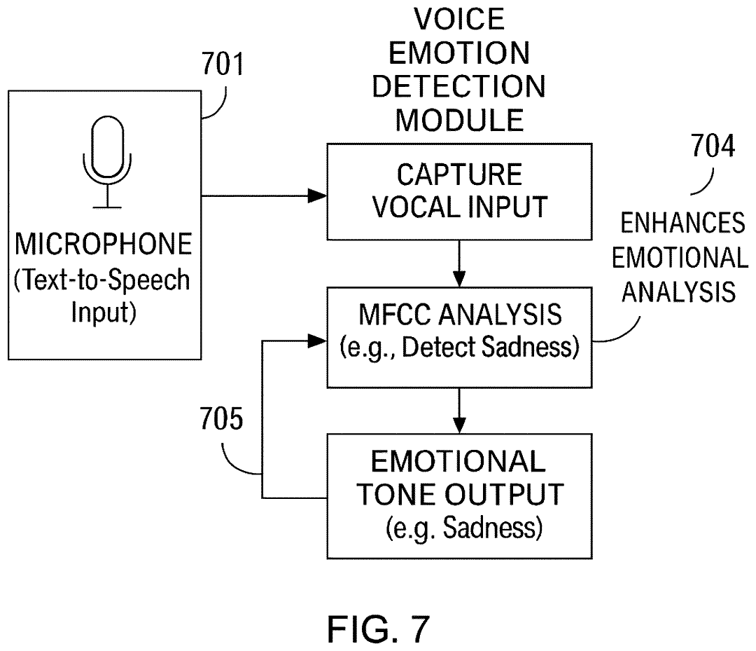

Diagram showing the voice analysis module processing text-to-speech inputs via MFCC analysis to detect emotional tones.

FIG. 8: Cross-Platform Emotional Consistency

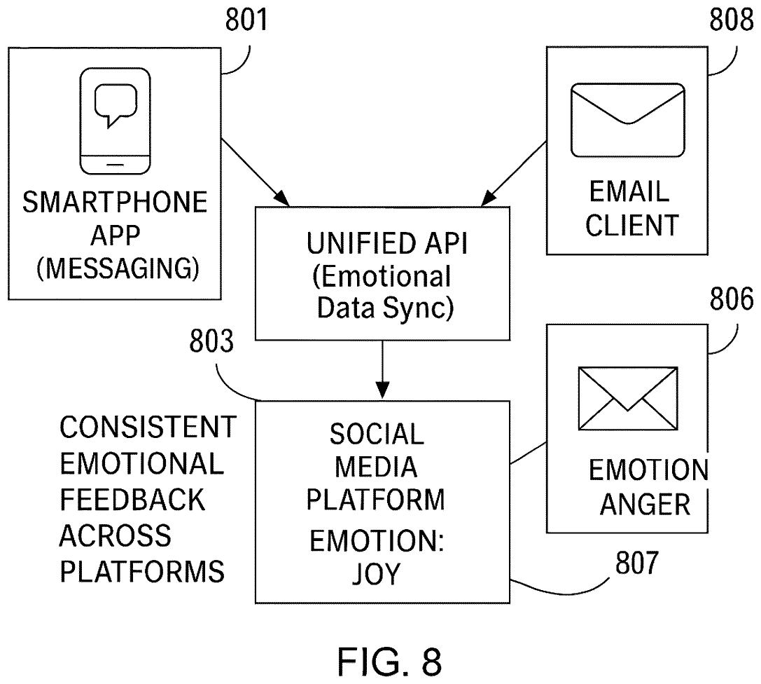

Illustration of the system providing consistent emotional feedback across smartphone apps, social media, and email clients via a unified API.

FIG. 9: User-defined Slang Mapping

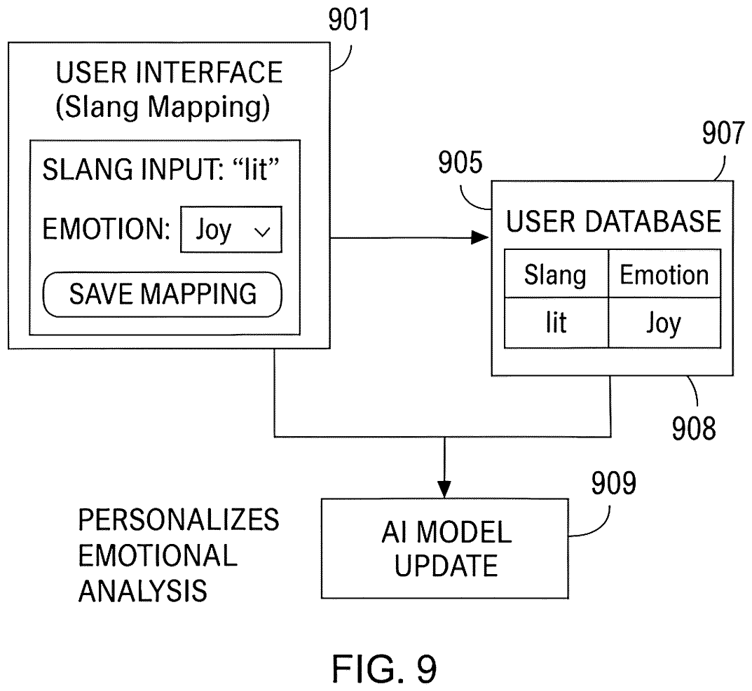

Diagram showing a user interface where users input slang (e.g., “lit” for joy) and map it to emotions, stored in a database for personalized AI learning.

1. A digital communication system comprising: an AI-driven emotion detection module implemented on a processor, the module configured to: (a) analyze typed text in real-time using a transformer-based natural language processing (NLP) model trained on an annotated emotional dataset to identify an emotional tone based on a hierarchical emotion classification framework comprising primary, secondary, and tertiary emotion categories; (b) assign a dominant emotion to the typed text and dynamically convert the text message color to a predefined color corresponding to the dominant emotion, as stored in a color-emotion mapping database; and (c) refine the NLP model weights in real-time by incorporating user-verified emotion feedback stored in a secure user-specific database, wherein the refinement uses supervised learning to adjust the model's emotional classification accuracy for individual users, achieving a processing latency of less than 100 milliseconds for text analysis.

2. The system of claim 1, further comprising a user feedback mechanism that allows the sender to verify or adjust the detected emotion before message transmission, enhancing the transformer-based NLP model's personalized emotional analysis over time by storing user-verified emotion labels in the secure user-specific database.

3. The system of claim 1, wherein the background color of the messaging screen dynamically adapts to the user's overall emotional tone over a set period, determined by the AI-driven emotion detection module's cumulative emotional analysis of recent messages using a time-series analysis algorithm.

4. The system of claim 1, further comprising an analytics engine that identifies and highlights specific messages contributing to the overall emotional trend, enabling users to identify key emotional drivers by generating a list of top messages that most significantly influenced the overall emotional state using a weighted scoring algorithm based on emotional intensity, as determined by the AI-driven emotion detection module.

5. The system of claim 4, wherein the analytics engine automatically generates alert messages to pre-identified contacts when significant negative emotional trends are detected based on predefined thresholds, such as sustained sadness or anger scores exceeding 80% over a 24-hour period, facilitating timely emotional support.

6. The system of claim 1, wherein the AI-driven emotion detection module further comprises a multimodal emotion detection component that integrates real-time facial emotion analysis using smartphone or computer cameras, enhancing the emotional context of digital messages via convolutional neural networks trained on facial expression datasets.

7. The system of claim 1, wherein the AI-driven emotion detection module further comprises a voice analysis component that detects emotional tone in spoken text-to-speech inputs, providing real-time emotional feedback based on vocal cues using mel-frequency cepstral coefficient (MFCC) analysis.

8. The system of claim 1, wherein the platform is configured for seamless use across smartphone text messaging apps, social media platforms, and computer email clients, ensuring a consistent emotional experience across all digital communication channels through a unified API that synchronizes emotional data processed by the AI-driven emotion detection module.

9. The system of claim 1, further comprising a user-defined slang mapping feature that allows users to add personalized slang or phrases and map them to specific emotions, enhancing the transformer-based NLP model's personalized emotional analysis based on unique user inputs stored in a user-accessible slang-emotion mapping database.

10. The system of claim 1, wherein the AI-driven emotion detection module is implemented on a cloud-based server with low-latency processing of less than 100 milliseconds for text analysis, ensuring real-time emotional feedback across all supported platforms.
